(19) United States
(12) Patent Application Publication
(10) Pub. No.: US 2025/0151141 A1
(43) Pub. Date: May 8, 2025

(54) ELECTRONIC DEVICE FOR COMMUNICATING WITH REMOTE CONTROL DEVICE AND CONTROL METHOD THEREFOR

(71) Applicant: Samsung Electronics Co., Ltd., Suwon-si (KR)

(72) Inventor: Yijun KIM, Suwon-si (KR)

(21) Appl. No.: 19/005,264

(22) Filed: Dec. 30, 2024

Related U.S. Application Data
(63) Continuation of application No. PCT/KR2023/012645, filed on Aug. 25, 2023.

(30) Foreign Application Priority Data
Oct. 12, 2022 (KR) 10-2022-0130933

(51) Int. Cl. H04W 76/14; H04W 48/16

(52) U.S. Cl. CPC H04W 76/14; H04W 48/16

(57) ABSTRACT

An electronic device is provided. The electronic device includes communication circuitry, memory storing one or more computer programs stored with area information corresponding to the electronic device in a space, and one or more processors communicatively coupled to the communication circuitry and the memory, wherein the one or more computer programs include computer-executable instructions that, when executed by the one or more processors individually or collectively, cause the electronic device to identify position information of a remote control device based on a signal received from the remote control device through the communication circuitry, transmit, based on the identified position information being identified as corresponding to the area information, a pairing request signal with the remote control device to a server, and perform, based on the remote control device being converted to a pairing mode based on the transmitted signal, pairing with the remote control device.

### CROSS-REFERENCE TO RELATED APPLICATION(S)

This application is a continuation application, claiming priority under § 365(c), of an International application No. PCT/KR2023/012645, filed on Aug. 25, 2023, which is based on and claims the benefit of a Korean patent application number 10-2022-0130933, filed on Oct. 12, 2022, in the Korean Intellectual Property Office, the disclosure of which is incorporated by reference herein in its entirety.

### BACKGROUND

### 1. Field

The disclosure relates to an electronic device and a control method therefor. More particularly, the disclosure relates to an electronic device for communicating with a remote control device capable of communicating with a plurality of devices in a space and a control method therefor.

### 2. Description of Related Art

Recently, electronic devices of various forms are being developed and supplied.

In the related art, electronic devices may be controlled using a remote control device corresponding to an electronic device, and the electronic devices may not be controlled using a remote control device corresponding to another electronic device.

Accordingly, if a plurality of electronic devices is provided in a home, remote control devices corresponding respectively to the plurality of electronic devices, that is, a plurality of remote control devices may be provided.

In order to lessen the inconvenience of having to find a remote control device corresponding to an electronic device that a user intends to control from among a plurality of remote control devices, a remote control device (e.g., an integrated remote control device, or the like) capable of controlling the plurality of electronic devices has been developed and supplied.

However, because the integrated remote control device of the related art requires a user command for performing pairing between the integrated remote control device and an electronic device to be controlled using the integrated remote control device, inconvenience to the user has not been resolved.

Accordingly, there has been a demand for a method that, while controlling the plurality of electronic devices using the remote control device, does not require an input process for a command selecting the electronic device that the user intends to control or performing pairing with the electronic device that the user intends to control.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a control method therefor.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, memory storing one or more computer programs stored with area information corresponding to the electronic device in a space, and one or more processors communicatively coupled to the communication circuitry and the memory, wherein the one or more computer programs include computer-executable instructions that, when executed by the one or more processors individually or collectively, cause the electronic device to identify position information of a remote control device based on a signal received from the remote control device through the communication circuitry, transmit, based on the identified position information being identified as corresponding to the area information, a pairing request signal with the remote control device to a server, and perform, based on the remote control device being converted to a pairing mode based on the transmitted signal, pairing with the remote control device.

In accordance with another aspect of the disclosure, a method performed by an electronic device including area information corresponding to an electrode device in a space is provided. The method includes identifying, by the electronic device, position information of a remote control device based on a signal received from the remote control device, transmitting, by the electronic device based on the identified position information being identified as corresponding to the area information, a pairing request signal with the remote control device to the server, and performing, by the electronic device based on the remote control device being converted to a pairing mode based on the transmitted signal, pairing with the remote control device.

In accordance with another aspect of the disclosure, one or more non-transitory computer-readable storage media storing one or more computer programs including computer-executable instructions that, when executed by one or more processors of an electronic device including area information corresponding to an electrode device in a space individually or collectively, cause the electronic device to perform operations are provided. The operations include identifying, by the electronic device, position information of a remote control device based on a signal received from the remote control device, transmitting, by the electronic device based on the identified position information being identified as corresponding to the area information, a pairing request signal with the remote control device to the server, and performing, by the electronic device based on the remote control device being converted to a pairing mode based on the transmitted signal, pairing with the remote control device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an electronic device and a remote control device according to an embodiment of the disclosure;

FIG. 2 is a block diagram illustrating a configuration of an electronic device according to an embodiment of the disclosure;

FIG. 3 is a diagram illustrating a method of identifying position information of a remote control device according to an embodiment of the disclosure;

FIG. 4 is a sequence diagram illustrating a method of obtaining and storing area information according to an embodiment of the disclosure;

FIG. 5 is a diagram illustrating area information corresponding respectively to an electronic device and an external electronic device according to an embodiment of the disclosure;

FIG. 6 is a sequence diagram illustrating an electronic device performing pairing with a remote control device according to an embodiment of the disclosure;

FIG. 7 is a diagram illustrating an electronic device transmitting connection information to a new external electronic device according to an embodiment of the disclosure;

FIG. 8 is a sequence diagram illustrating an electronic device transmitting connection information according to an embodiment of the disclosure; and

FIG. 9 is a flowchart illustrating a method of controlling an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, expressions, such as “have”, “may have”, “include”, and “may include” are used to designate a presence of a corresponding characteristic (e.g., elements, such as numerical value, function, operation, or component), and not to preclude a presence or a possibility of additional characteristics.

The expression at least one of A and/or B is to be understood as indicating any one of “A” or “B” or “A and B”.

Expressions, such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

It is to be understood that the terms, such as “configured” or “include” are used herein to designate a presence of a characteristic, number, operation, element, component, or a combination thereof, and not to preclude a presence or a possibility of adding one or more of other characteristics, numbers, operations, elements, components or a combination thereof.

The term “module” or “part” used herein perform at least one function or operation, and may be implemented with a hardware or software, or implemented with a combination of hardware and software. In addition, a plurality of “modules” or a plurality of “parts,” except for a “module” or a “part” which needs to be implemented with a specific hardware, may be integrated in at least one module and implemented as at least one processor (not shown).

In the disclosure, the term “user” may refer to a person using an electronic device or a device (e.g., artificial intelligence electronic device) using the electronic device.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

The disclosure will be described in greater detail below with reference to the accompanied drawings.

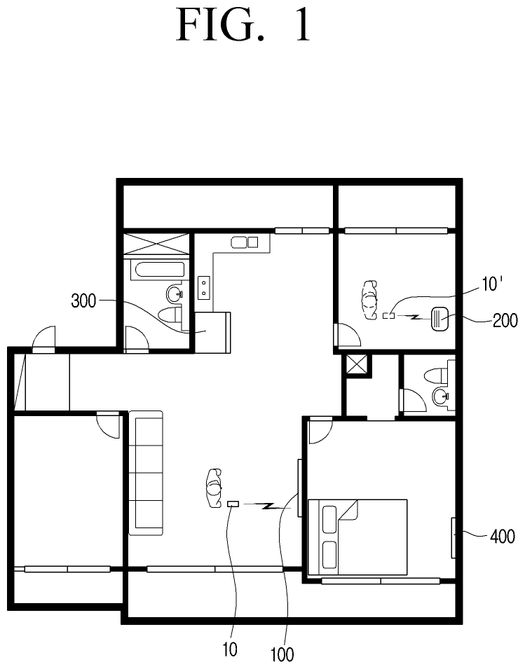

FIG. 1 is a diagram illustrating an electronic device and a remote control device according to an embodiment of the disclosure.

Referring to FIG. 1, as electronic devices of various types are being developed and supplied, a plurality of electronic devices 100, 200, 300, and 400 may be provided in homes.

Specifically, each of the plurality of electronic devices 100, 200, 300, and 400 may be implemented as Internet of things (IoT) and perform communication with another electronic device, a user terminal device, a remote control device 10, a server, and the like provided in a home.

In an example, as shown in FIG. 1, a first electronic device 100 (hereinafter, referred to as an electronic device) may be implemented as a first display device, a second electronic device 200 (hereinafter, referred to as a first external electronic device) may be implemented as an air purifier, a third electronic device 300 (hereinafter, referred to as a second external electronic device) may be implemented as a refrigerator, and a fourth electronic device 400 (hereinafter, referred to as a third external electronic device) may be implemented as a second display device.

However, this is one example, and each of the plurality of electronic devices 100, 200, 300, and 400 may be implemented as home appliances of various types, such as, for example, and without limitation, an air conditioning device, a kitchen/cooking device, a wired/wireless cleaning device, an image processing device, a clothing management device, or the like.

For example, each of the plurality of electronic devices 100, 200, 300, and 400 may include at least one from among, for example, and without limitation, a television (TV), a user terminal device, a tablet personal computer (PC), a mobile phone, a video telephone, an electronic book reader, a desktop PC, a laptop PC, a netbook computer, a workstation, a server, a personal digital assistance (PDA), a portable multimedia player (PMP), a moving picture experts group (MPEG) audio layer 3 (MP3) player, a medical device, a camera, a virtual reality (VR) implementation device, or a wearable device. Here, the wearable device may include at least one from among an accessory type (e.g., a watch, a ring, a bracelet, an anklet, a necklace, a pair of glasses, a contact lens or a head-mounted-device (HMD)), a fabric or a garment-embedded type (e.g., an electronic clothing), a skin-attached type (e.g., a skin pad or a tattoo), or a bio-implantable circuit. In some embodiments of the disclosure, each of the plurality of electronic devices 100, 200, 300, and 400 may include at least one from among, for example, a television, a digital video disk (DVD) player, an audio, a refrigerator, a cleaner, an oven, a microwave, a washing machine, an air purifier, a source device (e.g., a set top box, a cloud server, an over-the-top (OTT) media service server, or the like), a home automation control panel, a security control panel, a media box (e.g., Samsung HomeSync™, Apple TV™, or Google TV™), a game console (e.g., Xbox™, PlayStation™), an electronic dictionary, an electronic key, a camcorder, or an electronic frame.

In another embodiment of the disclosure, each of the plurality of electronic devices 100, 200, 300, and 400 may include at least one from among various medical devices (e.g., various portable medical measurement devices (glucose measuring device, a heart rate measuring device, a blood pressure measuring device, a temperature measuring device, or the like), a magnetic resonance angiography (MRA), a magnetic resonance imaging (MRI), a computed tomography (CT), an imaging apparatus, an ultrasonic device, or the like), a navigation device, a global navigation satellite system (GNSS), an event data recorder (EDR), a flight data recorder (FDR), a vehicle infotainment device, a nautical electronic equipment (e.g., nautical navigation device, gyro compass, or the like), an avionics electronic device, a security device, a vehicle head unit, an industrial or personal robot, a drone, an automated teller machine (ATM) of financial institutions, a point of sales (POS) of shops, or an internet of things device (e.g., light bulbs, various sensors, sprinkler devices, fire alarms, temperature adjusters, street lights, toasters, exercise equipment, hot water tanks, heaters, boilers, or the like).

In the related art, an electronic device may be controlled using a remote control device corresponding to the electronic device, and the electronic device may not be controlled using a remote control device corresponding to another electronic device. Accordingly, if a plurality of electronic devices are provided in a home, a remote control device corresponding to each of the plurality of electronic devices, that is, a plurality of remote control devices has been provided.

In order to reduce the inconvenience of having to find the remote control device corresponding to the electronic device that the user wishes to control from among the plurality of remote control devices, a remote control device (e.g., an integrated remote control device, or the like) capable of controlling the plurality of electronic devices has been developed and supplied.

An integrated remote control device of the related art required a user command for performing pairing between the integrated remote control device and an electronic device intended to be controlled using the integrated remote control device.

After performing pairing between the electronic device that a user intends to control from among the plurality of electronic devices and the integrated remote control device according to the user command, the electronic device may be controlled using the integrated remote control device. For example, an electronic device that is not paired with the integrated remote control device from among the plurality of electronic devices may not be controlled using the integrated remote control device.

In addition, if a new electronic device other than the plurality of electronic devices is provided in the home, there has been the inconvenience of a user command for performing pairing between the new electronic device and the integrated remote control device being required in order to control the new electronic device using the integrated remote control device.

Various embodiments of performing, without a user command, pairing between any one electronic device from among the plurality of electronic devices 100, 200, 300, and 400 and the remote control device 10, and controlling any one electronic device using a remote control device 10 or another remote control device 10′ will be described below. In addition, various embodiments of performing, without a user command, pairing between a new electronic device other than the plurality of electronic devices 100, 200, 300, and 400 and the remote control device 10 will be described.

Meanwhile, various embodiments of the electronic device 100 described below may be embodiments implementable in any one external electronic device from among a plurality of external electronic devices 200, 300, and 400, and various embodiments of any one external electronic device from among the plurality of external electronic devices 200, 300, and 400 may be embodiments implementable in the electronic device 100.

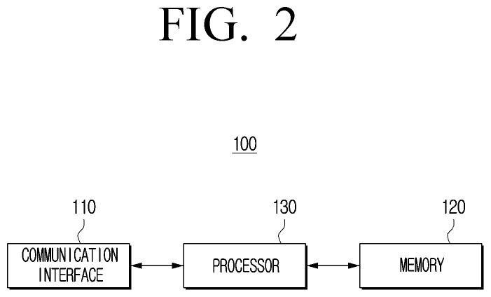

FIG. 2 is a block diagram illustrating a configuration of an electronic device according to an embodiment of the disclosure.

Referring to FIG. 2, an electronic device 100 may include a communication interface 110, memory 120, and one or more processors 130.

Here, the communication interface 110 (or communication circuitry) may communicate with an external device (e.g., a display device 200), an external server (e.g., WEBHARD, a streaming server), and the like through communication methods, such as, for example, and without limitation, an AP based Wi-Fi (e.g., Wi-Fi, wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), audio engineering society/European broadcasting union (AES/EBU), optical, coaxial, or the like.

Specifically, the electronic device 100 according to an example of the disclosure may communicate with the remote control device 10 using a Bluetooth-based communication interface 110.

According to an example, the memory 120 may store data necessary for an embodiment of the disclosure. The memory 120 may be implemented in a form of memory embedded in the electronic apparatus 100 according to a data storage use, or implemented in a form of memory attachable to or detachable from the electronic device 100.

For example, data for the driving of the electronic device 100 may be stored in the memory embedded in the electronic device 100, and data for an expansion function of the electronic device 100 may be stored in the memory attachable to or detachable from the electronic device 100. Meanwhile, the memory embedded in the electronic device 100 may be implemented as at least one from among volatile memory (e.g., dynamic random access memory (DRAM), static RAM (SRAM), or synchronous dynamic RAM (SDRAM)), or non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), a hard disk drive (HDD) or a solid state drive (SSD)). In addition, in the case of the memory attachable to or detachable from the electronic device 100, the memory may be implemented in a form, such as, for example, and without limitation, memory card (e.g., a compact flash (CF), a secure digital (SD), a micro secure digital (micro-SD), a mini secure digital (mini-SD), an extreme digital (xD), a multi-media card (MMC), or the like), external memory (e.g., USB memory) connectable to a USB port, or the like.

According to an example, the memory 120 may store a computer program including at least one instruction or instructions for controlling the electronic device 100.

According to an embodiment of the disclosure, various data may be stored in external memory of a processor 130, and a portion from among the data may be stored in internal memory of the processor 130 and remaining data may be stored in the external memory.

Specifically, the memory 120 according to an example may store area information corresponding to an electronic device 100 in a space.

Here, the space may mean inside a house in which the electronic device 100 is positioned, and because the plurality of electronic devices 100, 200, 300, and 400 is positioned in the house, sub spaces corresponding to each of the plurality of electronic devices 100, 200, 300, and 400 may be present in the space. For convenience of description, the sub spaces will be collectively referred to as areas below.

There may be a portion of an area that overlap between areas corresponding to each of the plurality of electronic devices 100, 200, 300, and 400, and there may not be a portion of an area that overlap.

The memory 120 according to an example may store area information including a size of an area and a range of an area corresponding to the electronic device 100 in the space.

According to an example of the disclosure, the one or more processors 130 may control an overall operation of the electronic device 100.

According to an embodiment of the disclosure, the processor 130 may be implemented as a digital signal processor (DSP) that processes digital signals, a microprocessor, or a time controller (TCON). However, the above is not limited thereto, and may include one or more from among a central processing unit (CPU), a micro controller unit (MCU), a micro processing unit (MPU), a controller, an application processor (AP), or a communication processor (CP), an ARM processor, an artificial intelligence (AI) processor, or may be defined by the corresponding term. In addition, the processor 130 may be implemented as a System on Chip (SoC) or a large scale integration (LSI) embedded with a processing algorithm, and may be implemented in a form of a field programmable gate array (FPGA). The processor 130 may perform various functions by executing computer executable instructions stored in the memory.

The one or more processors 130 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or a random combination from among other elements of the electronic device, and perform an operation associated with communication or data processing. The one or more processors 130 may execute one or more programs or instructions stored in the memory. For example, the one or more processors 130 may perform, by executing one or more instructions stored in the memory, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment of the disclosure, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The one or more processors 130 may be implemented as a single core processor that includes one core, or implemented as one or more multicore processors that include a plurality of cores (e.g., a homogeneous multicore or a heterogeneous multicore). If the one or more processors 130 are implemented as multicore processors, each of the plurality of cores included in the multicore processors may include memory inside the processor, such as cache memory and on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment of the disclosure, the first operation, the second operation, and the third operation may all be performed by a first core included in the multicore processors, or the first operation and the second operation may be performed by the first core included in the multicore processors and the third operation may be performed by a second core included in the multicore processors.

In one or more embodiments of the disclosure, the one or more processors 130 may refer to a system on chip (SoC), a single core processor, or multicore processors in which the one or more processors and other electronic components are integrated or a core included in the single core processor or the multicore processors, and the core herein may be implemented as the CPU, the GPU, the APU, the MIC, the DSP, the NPU, the hardware accelerator, the machine learning accelerator, or the like, but the embodiments of the disclosure are not limited thereto.

Specifically, the one or more processors 130 may identify position information of the remote control device 10, and perform, based on the identified position information corresponding to the area information (i.e., the area information corresponding to the electronic device 100), pairing with the remote control device 10 without a user command for performing pairing between the electronic device 100 and the remote control device 10.

First, according to an example, a method of the one or more processors 130 identifying position information of the remote control device 10, and a method of obtaining area information corresponding to the electronic device 100 will be described.

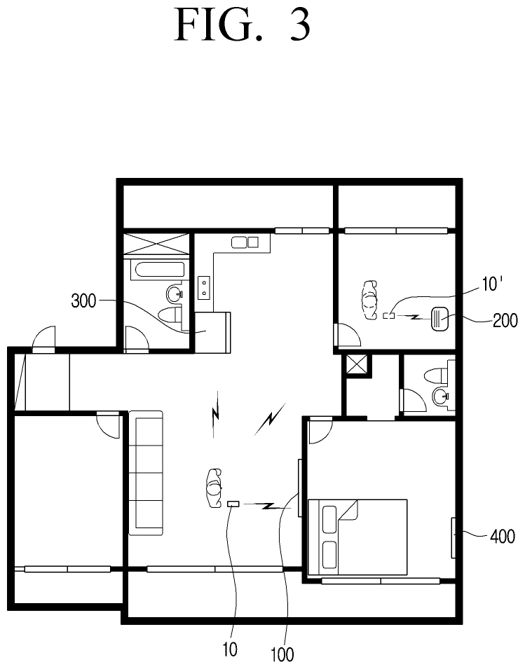

FIG. 3 is a diagram illustrating a method of identifying position information of a remote control device according to an embodiment of the disclosure.

Referring to FIG. 3, the one or more processors 130 may control the communication interface 110 to communicate with the remote control device 10.

Here, the communication interface 110 may communicate with the remote control device 10 in a Bluetooth-based communication method according to control by one or more processors 130.

According to an example, the communication interface 110 may receive a signal from the remote control device 10 using a beacon (e.g., a beacon based on Bluetooth low energy (BLE)), and the one or more processors 130 may identify position information based on the signal received from the remote control device 10. Here, the signal received from the remote control device 10 may include at least one from among a unicast signal, a multicast signal, or a broadcast signal transmitted by the remote control device 10.

For example, the one or more processors 130 may identify a strength of the signal received from the remote control device 10. Here, the strength of the signal may include a received signal strength indication (RSSI) value. For example, the RSSI value may be represented as a negative number (dBm, mW units), and may be represented in a value close to 0 the stronger the strength of the signal is. Accordingly, the RSSI value may be close to 0 as the distance between the electronic device 100 and the remote control device 10 becomes shorter, and the RSSI value may be farther from 0 as the distance between the electronic device 100 and the remote control device 10 become farther. An RSSI value according to an example may be represented in a value of between 0 (dBm) to −100 (dBm).

The one or more processors may identify a distance between the electronic device 100 and an external device based on the strength of the signal.

The one or more processors 130 may identify an angle of arrival (AoA) or an angle of departure (AoD) of the signal received from the remote control device 10.

For example, based on a Bluetooth 5.1 standard, the remote control device 10 may transmit a direction finding signal in a AoA method, the communication interface 110 may receive the direction finding signal using a plurality of antennas (or, an array antenna), and the one or more processors 130 may identify a relative direction (i.e., a direction of the remote control device 10 based on the electronic device 100) of the remote control device 10 based on a phase difference of the direction finding signal received through the communication interface 110.

For example, based on the Bluetooth 5.1 standard, the remote control device 10 may transmit the direction finding signal using the array antenna (plurality of antennas) in a AoD method, the communication interface 110 may receive the direction finding signal using one antenna, and the one or more processors 130 may identify the relative direction of the remote control device 10 based on the phase difference of the direction finding signal transmitted by the remote control device 10.

Then, the one or more processors 130 may obtain the distance information between the electronic device 100 and the remote control device 10, and the position information of the remote control device 10 based on the direction information of the remote control device 10.

Meanwhile, each of the plurality of external electronic devices 200, 300, and 400 in the space other than the electronic device 100 may also obtain the position information of the remote control device 10. For example, if the remote control device 10 transmits a multicast signal or a broadcast signal, each of the plurality of external electronic devices 200, 300, and 400 may also obtain the position information of the remote control device 10 based on the signal received from the remote control device 10.

For example, a second external electronic device 300 may also obtain distance information between the second external electronic device 300 and the remote control device 10 based on the signal received from the remote control device 10 and the position information of the remote control device 10 based on the direction information of the remote control device 10 with respect to the second external electronic device 300.

A method of the one or more processors 130 obtaining one area including position information in a space as area information and storing in the memory will be described below.

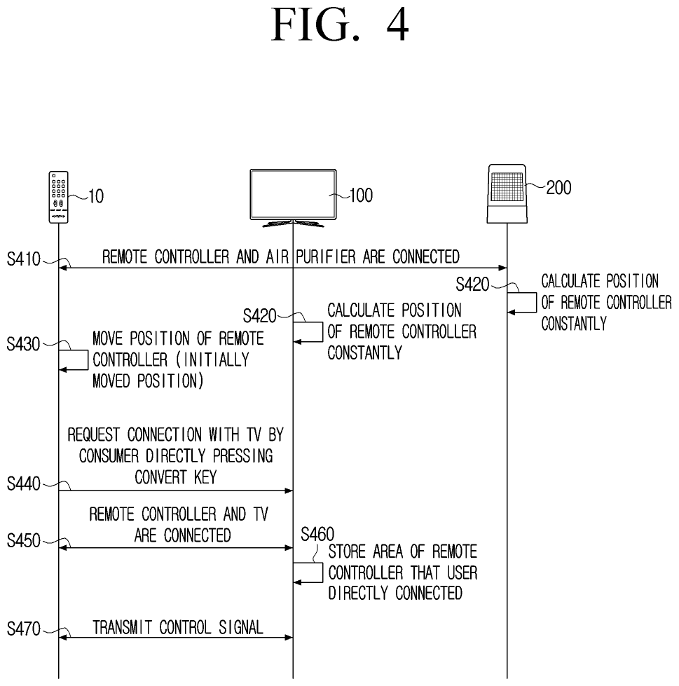

FIG. 4 is a sequence diagram illustrating a method of obtaining and storing area information according to an embodiment of the disclosure.

Referring to FIG. 4, the remote control device 10 and the first external electronic device 200 are paired in operation S410, and each of the electronic device 100 and first external electronic device 200 may identify the position information of the remote control device 10 based on the signal received from the remote control device 10 in operation S420.

Then, when the position of the remote control device 10 is moved in operation S430, and a user command for performing pairing between the remote control device 10 and the electronic device 100 is input in the remote control device in operation S440, the first external electronic device 200 may end the pairing between the first external electronic device 200 and the remote control device 10.

Then, the electronic device 100 may perform pairing with the remote control device 10 in a pairing mode in operation S450. Here, the pairing mode may be a mode for the remote control device 10 to perform pairing with a device positioned near the remote control device 10.

Then, the electronic device 100 may identify the position information of the remote control device 10 based on the signal received from the remote control device 10, and store one area including the identified position information as area information in operation S460.

For example, as shown in FIG. 1, the remote control device 10 that is paired with the first external electronic device 200 may end pairing with the first external electronic device 200, and the electronic device 100 may perform pairing with the remote control device 10 according to the user command after the remote control device 10 (e.g., a user grasping the remote control device 10) moves near the electronic device 100.

Then, the electronic device 100 may identify the position information of the remote control device 10 at a time-point of performing pairing with the remote control device 10 based on the signal (e.g., a control signal) received from the remote control device 10, and identify one area including the identified position information as area information corresponding to the electronic device 100.

Here, the position information of the remote control device identified by the electronic device 100 at the time-point of the electronic device 100 and the remote control device 10 performing pairing may mean a main position of the user (or, the user grasping the remote control device 10) intending to control the electronic device 100 using the remote control device 10.

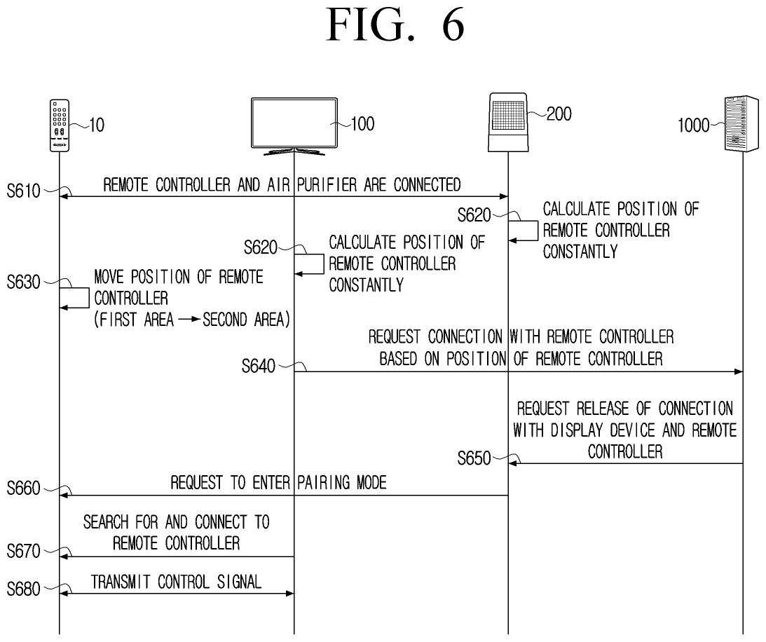

Then, the electronic device 100 may perform pairing with the remote control device 10 based on the position information of the remote control device 10 identified based on the signal received from the remote control device 10 corresponding to the main position (i.e., area information corresponding to the electronic device 100) of the user (or, the user grasping the remote control device 10) intending to control the electronic device 100 while pairing is not performed between the remote control device 10 and the electronic device 100. A detailed description thereof will be described below with reference to FIG. 6.

Meanwhile, the position information may mean coordinate information of (x, y), and the area information may mean a set including a plurality of position information, or one area including the plurality of position information.

Then, the electronic device 100 may operate based on the control signal received from the remote control device 10 in operation S470. In addition, the electronic device 100 may identify the one area including the position information of the remote control device 10 identified based on the control signal as area information corresponding to the electronic device 100.

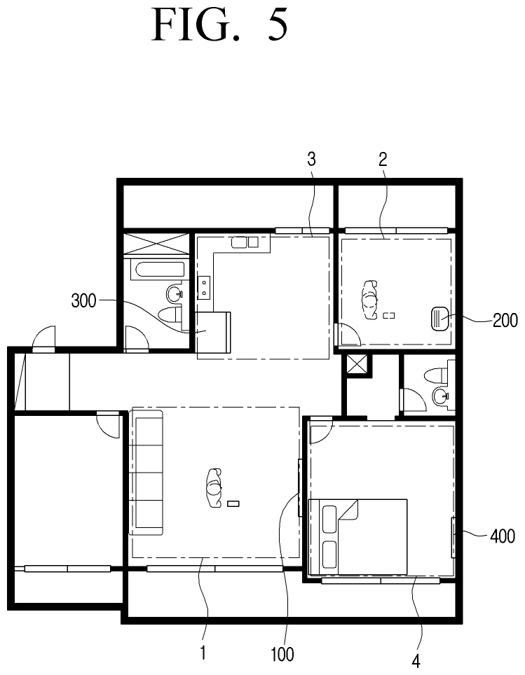

FIG. 5 is a diagram illustrating area information corresponding respectively to an electronic device and an external electronic device according to an embodiment of the disclosure.

Referring to FIG. 5, the electronic device 100 may obtain position information of the remote control device 10 at the time-point at which a control signal for controlling the electronic device 100 is received from the remote control device 10, and position information of the remote control device 10 at the time-point of performing pairing with the remote control device 10, and obtain area information 1 corresponding to the electronic device 100 based on the obtained plurality of position information.

In addition, the first external electronic device 200 may also obtain position information of the remote control device 10 at the time-point at which a control signal for controlling the first external electronic device 200 is received from the remote control device 10, and position information of the remote control device 10 at the time-point of performing pairing with the remote control device 10, and obtain area information 2 corresponding to the first external electronic device 200 based on the obtained plurality of position information.

The area information 1 corresponding to the electronic device 100 and the area information 2 corresponding to the first external electronic device 200 shown in FIG. 5 are merely one example, and a form, a size, and the like of the area information may vary.

FIG. 6 is a sequence diagram illustrating an electronic device performing pairing with a remote control device according to an embodiment of the disclosure.

Referring to FIG. 6, the remote control device 10 and the first external electronic device 200 are paired in operation S610, and each of the electronic device 100 and the first external electronic device 200 may identify position information of the remote control device 10 based on the signal received from the remote control device 10 in operation S620. Here, the remote control device 10 that is paired with the first external electronic device 200 may be positioned in an area 2 corresponding to the first external electronic device 200.

Then, when the position of the remote control device 10 is moved in operation S630, and the position of the remote control device 10 is identified as included in the area information 1 corresponding to the electronic device 100 based on the signal received from the remote control device 10, the electronic device 100 may transmit a pairing request signal with the remote control device 10 to a server 1000 in operation S640.

Then, the server 1000 may transmit, based on the pairing request signal being received, a pairing end request signal to the first external electronic device 200 that is paired with the remote control device 10 in operation S650.

Then, the first external electronic device 200 that is paired with the remote control device 10 may end pairing with the remote control device 10 when the pairing end request signal is received from the server 1000, and enter the remote control device 10 to the pairing mode in operation S660.

Then, the electronic device 100 may perform pairing with the remote control device 10 positioned in an area 1 corresponding to the electronic device 100 in operation S670.

Then, the electronic device 100 may operate, based on the control signal being received from the remote control device 10, according to the received control signal in operation S680.

Meanwhile, according to an embodiment of the disclosure, it may be assumed that the electronic device 100 and the first external electronic device 200 perform a peer-to-peer (P2P) communication. In this case, the electronic device 100 may transmit, based on the position of the remote control device 10 that is paired with the first external electronic device 200 being identified as included in the area information 1 corresponding to the electronic device 100, the pairing end request signal to the first external electronic device 200. Then, the first external electronic device 200 that is paired with the remote control device 10 may end pairing with the remote control device 10 when the pairing end request signal is received from the electronic device 100, and also enter the remote control device 10 in the pairing mode.

In the above-described example, it may be assumed that each of the electronic device 100 and the first external electronic device 200 store connection information (e.g., unique Mac Address information and the like of the remote control device 10) of the remote control device 10.

For example, the electronic device 100 may perform, based on the position information of the remote control device 10 corresponding to area information 1 corresponding to the electronic device 100, pairing with the remote control device 10 in pairing mode based on connection information stored in the electronic device 100.

In another example, if the connection information of the remote control device 10 is not stored in the second external electronic device 300, the second external electronic device 300 may not automatically perform pairing with the remote control device 10 in pairing mode. For example, the second external electronic device 300 may perform pairing with the remote control device 10 by obtaining the connection information of the remote control device 10 when a user input of selecting the remote control device 10 in pairing mode is received from a Bluetooth device list provided through a display provided in the second external electronic device 300, and only when a PIN or a code provided through the display is input in the remote control device 10.

According to an example of the disclosure, a method of obtaining connection information of the remote control device 10 to perform pairing between the second external electronic device 300 and the remote control device 10 when a new electronic device (hereinafter, referred to as the second external electronic device 300) other than the electronic device 100 and the first external electronic device 200 is provided in a space, and a method of the second external electronic device 300 obtaining area information corresponding to the second external electronic device 300 will be described below.

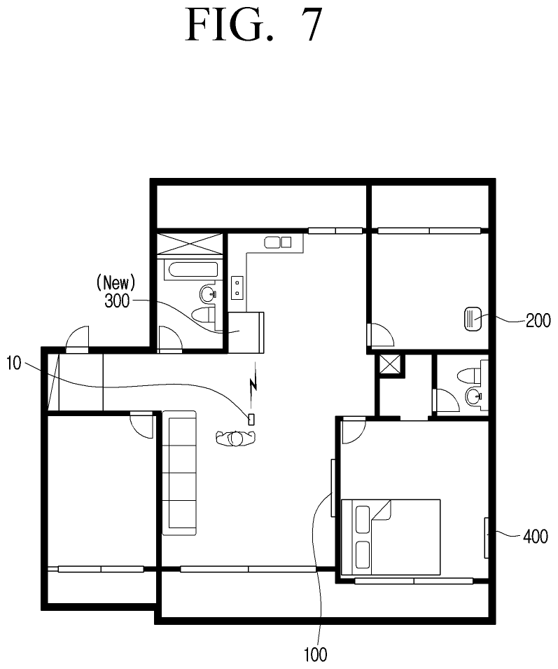

FIG. 7 is a diagram illustrating an electronic device transmitting connection information to a new external electronic device according to an embodiment of the disclosure.

Referring to FIG. 7, it may be assumed that a new electronic device (i.e., the second external electronic device 300) other than the electronic device 100 and the first external electronic device 200 is provided in a space.

Here, the new electronic device may mean an electronic device that has no history of having performed pairing with the remote control device 10 or an electronic device that has no connection information of the remote control device 10 stored therein.

According to an example, the electronic device that has a history of having performed pairing with the remote control device 10, such as the electronic device 100 and the first external electronic device 200 or, the electronic device that has connection information of the remote control device 10 stored therein may transmit the connection information to the new electronic device.

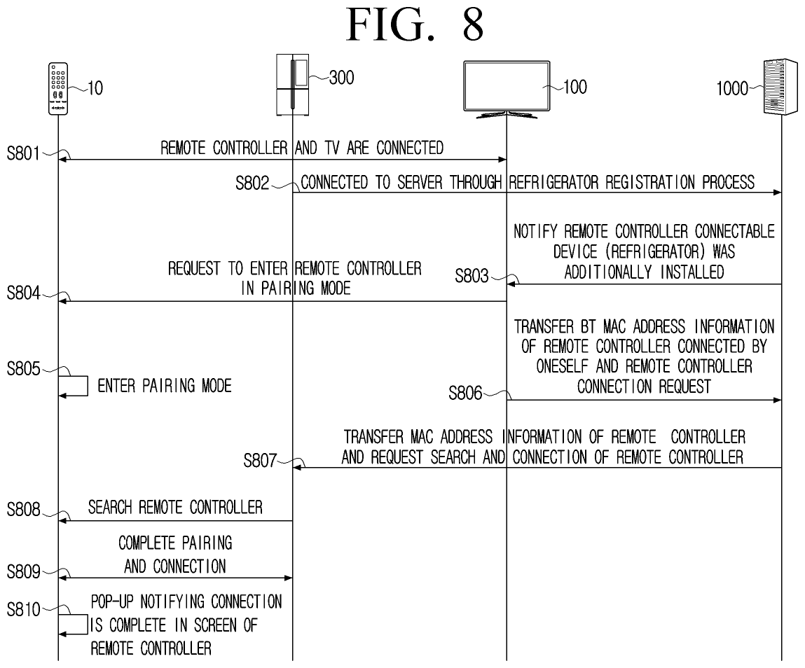

Detailed descriptions thereof will be provided with reference to FIG. 8.

FIG. 8 is a sequence diagram illustrating an electronic device transmitting connection information according to an embodiment of the disclosure.

Referring to FIG. 8, the remote control device 10 and the electronic device 100 are paired in operation S801, and the second external electronic device 300 may be registered to a user account through the server 1000 in operation S802.

Here, when the second external electronic device 300 is registered to a user account, each of the electronic device 100 and the first external electronic device 200 that were pre-registered in the same user account may transmit the connection information, the pairing end request signal, and the like of the remote control device 10 to the second external electronic device 300 through the server 1000.

Conversely, if the second external electronic device 300 is registered to a user account, the second external electronic device 300 may transmit the connection information, the pairing end request signal, and the like to each of the electronic device 100 and the first external electronic device 200 that were pre-registered in the same user account through the server 1000.

Then, the server 1000 may transmit, based on the second external electronic device 300 being registered to a user account, registration information indicating that the second external electronic device 300 has been registered to the user account to the electronic device 100 that had been pre-registered to the same user account in operation S803.

Then, the electronic device 100 may end, based on registration information being received from the server 1000, pairing with the remote control device 10, and enter the remote control device 10 in the pairing mode in operation S804.

Then, the remote control device 10 may enter pairing mode in operation S805, and in operation S806, the electronic device 100 that ended pairing with the remote control device 10 may transmit connection information of the remote control device 10 to the second external electronic device 300 through the server 1000 in operations S806 and S807.

Then, when the connection information of the remote control device 10 is received, the second external electronic device 300 may search the remote control device 10 based on the connection information in operation S808, and perform pairing with the remote control device 10 in operation S809.

Then, if the remote control device 10 includes a display, the remote control device 10 may provide a notification indicating that pairing is complete through the display in operation S810.

Then, the second external electronic device 300 may store, thereafter, the position information of the remote control device 10 at the time-point at which pairing of the remote control device 10 and the second external electronic device 300 is performed, and the position information of the remote control device 10 at the time-point at which a control signal for controlling the second external electronic device 300 is received from the remote control device 10 in order to obtain area information corresponding to the second external electronic device 300, and obtain area information 3 corresponding to the second external electronic device 300 based on the plurality of position information stored in the second external electronic device 300.

Meanwhile, the electronic device 100 and the first external electronic device 200 (or, the second external electronic device 300) that were pre-stored to the same user account may share device information corresponding respectively thereto with each other and perform P2P communication. If the electronic device 100 and the first external electronic device 200 perform P2P communication, connection information of the remote control device 10 may be transmitted or the pairing end request signal may be transmitted from any one from among the electronic device 100 and the first external electronic device 200 to the remaining other without passing through the server 1000.

Referring back to FIG. 2, the electronic device 100 according to an embodiment of the disclosure may identify the position information of the remote control device 10 based on the signal received from the remote control device 10 that is paired with the electronic device 10, and end, based on the identified position information not corresponding to the area information corresponding to the electronic device 100, pairing with the remote control device 10 and enter the remote control device 10 in the pairing mode.

Then, the remote control device 10 in pairing mode may perform pairing with a device (e.g., the first external electronic device 200) near the remote control device 10.

Meanwhile, the one or more processors 130 may also accumulate and continuously update the position information (e.g., the position information of the remote control device 10 at the time-point at which the remote control device 10 and the electronic device 100 perform pairing, and the position information of the remote control device 10 at the time-point at which the control signal for controlling the electronic device 100 is received from the remote control device 10) of the remote control device 10 obtained by the electronic device 100 while the electronic device 100 is in operation.

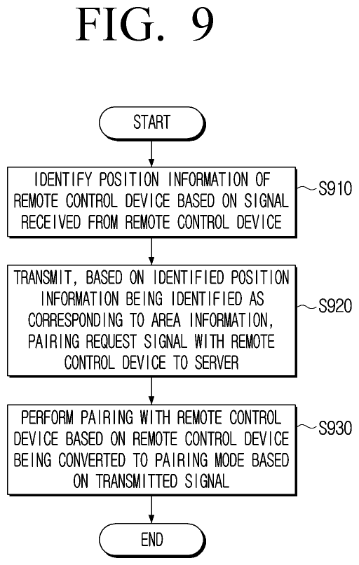

FIG. 9 is a flowchart illustrating a method of controlling an electronic device according to an embodiment of the disclosure.

Referring to FIG. 9, a method of controlling the electronic device including area information corresponding to the electronic device in the space may include, first, identifying the position information of the remote control device based on the signal received from the remote control device in operation S910.

Then, if the identified position information is identified as corresponding to the area information, transmitting the pairing request signal with the remote control device to the server in operation S920.

Then, if the remote control device is converted to the pairing mode based on the transmitted signal, performing pairing with the remote control device in operation S930.

Here, the operation S930 of performing pairing may include performing, based on the remote control device that is paired with the external electronic device positioned in the space being converted to the pairing mode according to the pairing request signal, pairing with the remote control device based on the connection information of the remote control device.

Here, the pairing mode may be a mode for the remote control device to perform pairing with a device positioned near the remote control device.

The method according to an example may include ending, based on the registration information of the external electronic device in the space being received from the server, pairing with the remote control device and transmitting the connection information of the remote control device for pairing of the external electronic device and the remote control device to the server.

According to an example, operation S910 of identifying position information may include obtaining distance information between the remote control device and the electronic device based on the strength of the received signal, obtaining the direction information of the remote control device with respect to the electronic device based on at least one from among the angle of arrival (AoA) or the angle of departure (AoD) of the received signal, and identifying the position information based on the distance information and the direction information.

The method according to an example may further include storing one area including the position information in the space as area information.

According to an example, operation 910 of identifying position information may include identifying, based on the control signal being received from the remote control device that is paired with the electronic device, the position information of the remote control device based on the control signal, and the method may further include performing an operation corresponding to the control signal and obtaining one area including the identified position information as the area information.

The method according to an example may further include transmitting the registration information of the electronic device to the external electronic device in the space by registering the electronic device to the user account through the server and storing the connection information when the connection information is received from the external electronic device that is paired with the remote control device, and operation S930 of performing pairing may include performing pairing with the remote control device based on the connection information.

According to an example, each of the electronic device and the external electronic device may be registered to a user account.

The method according to an example may further include identifying the position information of the remote control device based on the control signal received from the remote control device that is paired with the electronic device, and ending, based on the identified position information not corresponding to the area information, pairing with the remote control device.

According to an example, the area information corresponding to the electronic device may vary from the area information corresponding to the external electronic device in the space.

However, the various embodiments of the disclosure may be applied to not only the electronic device, but also to electronic devices of various types.

Meanwhile, the various embodiments described above may be implemented in a recordable medium which is readable by a computer or a device similar to the computer using software, hardware, or the combination of software and hardware. In certain cases, the embodiments described herein may be implemented with the processor itself. According to a software implementation, embodiments of the disclosure, such as procedures and functions described herein may be implemented with separate software modules. Each of the software modules may perform one or more functions and operations described herein.

Meanwhile, the computer instructions for performing processing operations of the electronic device according to the various embodiments of the disclosure described above may be stored in a non-transitory computer-readable medium. The computer instructions stored in this non-transitory computer-readable medium may cause a specific device to perform the processing operations in the electronic device according to the above-described various embodiments when executed by a processor of the specific device.

The non-transitory computer-readable medium may refer to a medium that stores data semi-permanently rather than a medium that stores data for a very short time, such as a register, a cache, memory, or the like, and is readable by a device. Specific examples of the non-transitory computer-readable medium may include, for example, and without limitation, a compact disc (CD), a digital versatile disc (DVD), a hard disc, a Blu-ray disc, USB, memory card, ROM, and the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
memory storing one or more computer programs stored with area information corresponding to the electronic device in a space; and
one or more processors communicatively coupled to the communication circuitry and the memory,
wherein the one or more computer programs include computer-executable instructions that, when executed by the one or more processors individually or collectively, cause the electronic device to:
identify position information of a remote control device based on a signal received from the remote control device through the communication circuitry,
transmit, based on the identified position information being identified as corresponding to the area information, a pairing request signal with the remote control device to a server, and
perform, based on the remote control device being converted to a pairing mode based on the transmitted signal, pairing with the remote control device.

2. The electronic device of claim 1,
wherein the memory is configured to store connection information of the remote control device,
wherein the one or more computer programs further include computer-executable instructions that, when executed by the one or more processors individually or collectively, cause the electronic device to perform, based on the remote control device that is performing pairing with an external electronic device positioned in the space being converted to a pairing mode according to the pairing request signal, pairing with the remote control device based on the connection information, and
wherein the pairing mode is a mode for the remote control device to perform pairing with a device positioned near the remote control device.

3. The electronic device of claim 1,
wherein the memory is configured to store connection information of the remote control device, and
wherein the one or more computer programs further include computer-executable instructions that, when executed by the one or more processors individually or collectively, cause the electronic device to:
end, based on registration information of an external electronic device in the space being received from the server, pairing with the remote control device, and
transmit the connection information of the remote control device to the server to perform pairing of the external electronic device with the remote control device.

4. The electronic device of claim 1, wherein the one or more computer programs further include computer-executable instructions that, when executed by the one or more processors individually or collectively, cause the electronic device to:
obtain distance information between the remote control device and the electronic device based on a strength of the received signal,
obtain direction information of the remote control device with respect to the electronic device based on at least one from among an angle of arrival (AoA) or an angle of departure (AoD) of the received signal, and
identify the position information based on the distance information and the direction information.

5. The electronic device of claim 1, wherein the one or more computer programs further include computer-executable instructions that, when executed by the one or more processors individually or collectively, cause the electronic device to:
obtain one area comprising the position information in the space as the area information and store the same in the memory.

6. The electronic device of claim 1, wherein the one or more computer programs further include computer-executable instructions that, when executed by the one or more processors individually or collectively, cause the electronic device to:
perform, based on a control signal being received from the remote control device that is performing pairing with the electronic device, an operation corresponding to the control signal, and identify the position information of the remote control device based on the control signal, and
obtain one area comprising the identified position information as the area information and store the same in the memory.

7. The electronic device of claim 1, wherein the one or more computer programs further include computer-executable instructions that, when executed by the one or more processors individually or collectively, cause the electronic device to:
register the electronic device to a user account through the server and transmit registration information of the electronic device to an external electronic device in the space,
store, based on connection information being received from the external electronic device that is performing pairing with the electronic device, the connection information in the memory, and
perform pairing with the remote control device based on the connection information.

8. The electronic device of claim 7, wherein the electronic device and the external electronic device are respectively registered to the user account.

9. The electronic device of claim 1, wherein the one or more computer programs further include computer-executable instructions that, when executed by the one or more processors individually or collectively, cause the electronic device to:
identify the position information of the remote control device based on a control signal received from the remote control device that is performing pairing with the electronic device, and
end pairing with the remote control device based on the identified position information not corresponding to the area information.

10. The electronic device of claim 8, wherein area information corresponding to the electronic device is different from area information corresponding to the external electronic device in the space.

11. A method performed by an electronic device comprising area information corresponding to an electrode device in a space, the method comprising:
identifying, by the electronic device, position information of a remote control device based on a signal received from the remote control device;
transmitting, by the electronic device based on the identified position information being identified as corresponding to the area information, a pairing request signal with the remote control device to a server; and
performing,, by the electronic device based on the remote control device being converted to a pairing mode based on the transmitted signal, pairing with the remote control device.

12. The method of claim 11,
wherein the performing of the pairing comprises:
performing, based on the remote control device that is performing pairing with an external electronic device positioned in the space being converted to the pairing mode according to the pairing request signal, pairing with the remote control device based on connection information with the remote control device, and
wherein the pairing mode is a mode for the remote control device to perform pairing with a device positioned near the remote control device.

13. The method of claim 11, further comprising:
ending pairing with the remote control device based on registration information of an external electronic device in the space being received from the server; and
transmitting connection information of the remote control device to the server to perform pairing of the external electronic device with the remote control device.

14. The method of claim 11, wherein the identifying of the position information comprises:
obtaining distance information between the remote control device and the electronic device based on a strength of the received signal;
obtaining direction information of the remote control device with respect to the electronic device based on at least one from among an angle of arrival (AoA) or an angle of departure (AoD) of the received signal; and
identifying the position information based on the distance information and the direction information.

15. The method of claim 11, further comprising:
obtaining one area comprising the position information in the space as the area information and storing the same in memory.

16. The method of claim 11, further comprising:
performing, based on a control signal being received from the remote control device that is performing pairing with the electronic device, an operation corresponding to the control signal, and identifying the position information of the remote control device based on the control signal; and
obtaining one area comprising the identified position information as the area information and store the same in memory.

17. The method of claim 11, further comprising:
registering the electronic device to a user account through the server and transmit registration information of the electronic device to an external electronic device in the space;
storing, based on connection information being received from the external electronic device that is performing pairing with the electronic device, the connection information in memory; and
performing pairing with the remote control device based on the connection information.

18. The method of claim 17, wherein the electronic device and the external electronic device are respectively registered to the user account.

19. One or more non-transitory computer-readable storage media storing one or more computer programs including computer-executable instructions that, when executed by one or more processors of an electronic device comprising area information corresponding to an electrode device in a space individually or collectively, cause the electronic device to perform operations, the operations comprising
identifying, by the electronic device, position information of a remote control device based on a signal received from the remote control device;
transmitting, by the electronic device based on the identified position information being identified as corresponding to the area information, a pairing request signal with the remote control device to a server; and
performing, by the electronic device based on the remote control device being converted to a pairing mode based on the transmitted signal, pairing with the remote control device.

20. The one or more non-transitory computer-readable storage media of claim 19, the operations further comprising:
performing, based on the remote control device that is performing pairing with an external electronic device positioned in the space being converted to the pairing mode according to the pairing request signal, pairing with the remote control device based on connection information with the remote control device,
wherein the pairing mode is a mode for the remote control device to perform pairing with a device positioned near the remote control device.
